(19) United States
(12) Patent Application Publication
(10) Pub. No.: US 2008/0204764 A1
(43) Pub. Date: Aug. 28, 2008

(54) LEAD TERMINAL INSPECTION METHOD AND LEAD TERMINAL INSPECTION APPARATUS

(76) Inventor: Atsushi KIMURA, Nara (JP)

Correspondence Address: BIRCH STEWART KOLASCH & BIRCH, PO BOX 747, FALLS CHURCH, VA, 22040-0747, US

(21) Appl. No.: 12/037,747

(22) Filed: Feb. 26, 2008

(30) Foreign Application Priority Data
Feb. 27, 2007 (JP) 2007-047568

(51) Int. Cl. G01B 11/24

(52) U.S. Cl. 356/601

(57) ABSTRACT

In one embodiment, the present invention provides a lead terminal inspection method for inspecting the shape condition of lead terminals of an electronic apparatus by irradiating irradiation light from an optical sensor to the lead terminals, and detecting reflected light reflected from the lead terminals with the optical sensor. The optical sensor irradiates irradiation light having a diameter not greater than the width in the irradiation direction of the lead terminals to a detection target tip position of each lead terminal, and detects reflected light reflected from the lead terminals. Furthermore, the irradiation of the irradiation light and the detection of the reflected light are performed successively for the plurality of lead terminals by relatively moving either one of the optical sensor and the lead terminals relative to the other in the arrangement direction of the lead terminals, thereby counting the number of the lead terminals.

### BACKGROUND OF THE INVENTION

1. Field of the Invention

This application claims priority under 35 U.S.C. §119(a) on Patent Application No. 2007-047568 filed in Japan on Feb. 27, 2007, the entire contents of which are hereby incorporated herein.

The present invention relates to a lead terminal inspection method and a lead terminal inspection apparatus that determine whether or not the lead terminals of, for example, an electronic apparatus such as an electronic tuner, are acceptable.

2. Description of Related Art

The lead terminals of an electronic tuner (electronic apparatus) may sometimes suffer a length shortage caused by breakage, or by intrusion into the housing (lid). Because the lead terminals are used to connect to a wiring board or the like, they are required to have a certain length. If the length is insufficient, the connection to a wiring board or the like may not be established properly For this reason, the lead terminals of electronic tuners are subjected to an inspection in the product inspection process.

FIG. 12 is a diagram illustrating a state in which the lead terminals of an electronic tuner are visually inspected according to a lead terminal inspection method of Conventional Example 1.

The lead terminal inspection method according to Conventional Example 1 is a visual inspection in which lead terminals 101t of an electronic tuner 101 are observed and evaluated by a worker. Accordingly, the problem arises that variations in judgment or erroneous judgments occur depending on differences in fatigue/education level of the workers, and thus the accuracy and productivity are unstable.

FIG. 13 is a diagram illustrating a state in which the lead terminals of an electronic tuner are inspected using a dedicated inspection apparatus, which is a lead terminal inspection method (a lead terminal inspection apparatus) of Conventional Example 2.

The lead terminal inspection method according to Conventional Example 2 is a method in which the lead terminals 101t of an electronic tuner 101 are inserted into lead-terminal insertion pores 150t of a lead terminal inspection apparatus 150, which is a dedicated inspection apparatus, for electrical inspection. The inspection using the lead terminal inspection apparatus 150 has the problem that every time products having a different number of lead terminals 101t are developed, it is necessary to prepare a new lead terminal inspection apparatus 150, which requires an additional cost or the like, so that cost efficiency (productivity) becomes low.

In addition to Conventional Examples 1 and 2, the following lead terminal inspection methods and lead terminal inspection apparatuses using an optical sensor have been proposed.

JP S61-233304A discloses a lead inspection method for detecting a deformed lead of an electronic component (LSI) using an optical sensor. More specifically, this method is an inspection method in which an optical sensor that projects light to a lead of the electronic component and detects a deformed lead using the reflected light is moved such that the light is successively projected to a plurality of leads, and the acceptability of the shape of the leads of the electronic component is determined based on the maximum value of the differences in the waveforms output from the optical sensor.

According to this method, the acceptability of the leads is determined using the waveforms output from the optical sensor, so it is necessary to detect the differences of the waveforms, control the moving velocity of the optical sensor and the light-irradiation direction, and the like. This complicates the configuration, and the implementation is not easy. Furthermore, this method requires a dedicated inspection table or the like, and thus is problematic in terms of versatility, cost, control, and the like.

JP H9-145333A discloses an inspection apparatus that detects a bent terminal of an electronic component. More specifically, this document proposes an inspection apparatus provided with a light projecting means that emits a beam of light having a width greater than the width of the terminal in a direction parallel to the arrangement direction of the terminals of an electronic component, a light receiving means that receives the beam of light, a computing means that computes data of the emitted beam of light and data of the received beam of light to determine the width over which the light has been interrupted, and a determining means that determines the acceptability by comparing the width over which the light has been interrupted that is output from the computing means with a predetermined reference value. However, in this apparatus, it is necessary to determine the width over which the light has been interrupted through the computation of the data of the beam of light, and it is thus necessary to have a computing means capable of performing complicated computations, and the like, which means expensive equipment is necessary. Accordingly, there is a problem in terms of productivity, cost efficiency, and the like.

JP S63-177599A discloses a detection method for detecting a floating lead terminal of an electronic component. However, application of this method is limited to only the detection of a floating lead terminal, and thus there is a problem in that it is completely impossible to employ this method as a general lead terminal inspection method or in a lead terminal inspection apparatus.

As described above, the conventional examples have problems; the visual inspection is problematic in terms of accuracy and productivity, and the use of an optical sensor requires the detection of the differences of the output waveforms and a complicated configuration such as a computing means.

### SUMMARY OF THE INVENTION

The present invention was made in view of such circumstances, and it is an object thereof to provide a lead terminal inspection method and a lead terminal inspection apparatus that have a simple configuration and can determine whether or not lead terminals are acceptable with high accuracy in an easy and efficient manner by irradiating irradiation light having a diameter not greater than the width in the irradiation direction of the lead terminals to a detection target tip position of each lead terminal to detect the lead terminals, and counting the lead terminals.

A lead terminal inspection method according to the present invention is a lead terminal inspection method for inspecting the shape condition of lead terminals of an electronic apparatus by irradiating irradiation light from an optical sensor to the lead terminals and detecting reflected light reflected from the lead terminals with the optical sensor, the optical sensor being configured to irradiate irradiation light having a diameter not greater than the width in the irradiation direction of the lead terminals to a detection target tip position of each lead terminal and detect reflected light reflected from the lead terminal, wherein the irradiation of the irradiation light and the detection of the reflected light are performed successively for the plurality of lead terminals by relatively moving either one of the optical sensor and the lead terminals relative to the other in the arrangement direction of the lead terminals, thereby counting the number of the lead terminals.

According to this configuration, reflected light generated according to the shape condition at the detection target tip position of the lead terminals is detected, and the number of the lead terminals can be obtained based on the detection of the reflected light, whereby the detection of a lead terminal having a defective shape (breakage, deformation, length shortage due to intrusion into the housing of the electronic apparatus, misalignment due to deformation, etc.) can be effected, and the inspection to determine whether or not the lead terminals are acceptable can be performed with high accuracy in an easy and efficient manner.

Furthermore, in the lead terminal inspection method according to the present invention, while the electronic apparatus is fixed, the optical sensor is moved.

According to this configuration, a highly accurate detection can be achieved with a simple movable structure simply by moving the optical sensor parallel to the arrangement direction of the lead terminals.

In the lead terminal inspection method according to the present invention, while the optical sensor is fixed, the lead terminals are moved.

According to this configuration, it is only necessary to move the electronic apparatus linearly in the arrangement direction of the lead terminals while the optical sensor is fixed, whereby the optical paths of the irradiation light and the reflected light can be stabilized, and thus a highly accurate detection can be achieved. Furthermore, the manufacturing process can be carried out in-line.

Furthermore, the lead terminal inspection method according to the present invention is a lead terminal inspection method for inspecting the shape condition of lead terminals of an electronic apparatus by disposing a light emitting unit of an optical sensor and a light receiving unit of the optical sensor such that the light emitting unit and the light receiving unit face each other in a direction that intersects with the arrangement direction of the lead terminals, irradiating irradiation light from the light emitting unit to the lead terminals, and detecting the irradiation light with the light receiving unit, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal, wherein the irradiation of the irradiation light and the detection of an interruption of the irradiation light are performed successively for the plurality of lead terminals by relatively moving either one of the optical sensor and the lead terminals relative to the other in the arrangement direction, thereby counting the number of the lead terminals.

According to this configuration, because an interruption of the irradiation light generated according to the shape condition at the detection target tip position of normal lead terminals can be detected, and the number of the lead terminals can be counted based on the detection of the interruptions of the irradiation light, the inspection to determine whether or not the lead terminals 1t are acceptable can be performed with high accuracy in an easy and efficient manner by detecting a lead terminal 1t having a defective shape (breakage, deformation, length shortage due to intrusion into the housing 1c of the electronic tuner 1, misalignment due to deformation, etc.).

Furthermore, in the lead terminal inspection method according to the present invention, while the electronic apparatus is fixed, the light emitting unit and the light receiving unit are moved in synchronization with each other.

According to this configuration, it is only necessary to move the light emitting unit and the light receiving unit of the optical sensor parallel to the arrangement direction of the lead terminals, whereby a highly accurate detection can be achieved with a simple movable structure.

Furthermore, in the lead terminal inspection method according to the present invention, while the light emitting unit and the light receiving unit are fixed, the lead terminals are moved.

According to this configuration, it is only necessary to move the electronic apparatus linearly in the arrangement direction of the lead terminals while the optical sensor is fixed, whereby the optical paths of the irradiation light and reflected light can be stabilized, and thus a highly accurate detection can be achieved.

Furthermore, a lead terminal inspection method according to the present invention is a lead terminal inspection method for inspecting the shape condition of lead terminals of an electronic apparatus by disposing a light emitting unit of an optical sensor and a light receiving unit of the optical sensor such that the light emitting unit and the light receiving unit face each other in a direction that intersects with the arrangement direction of the lead terminals, irradiating irradiation light from the light emitting unit to the lead terminals, and detecting the irradiation light with the light receiving unit, the lead terminals being arranged in a plurality of rows, the sensor being disposed in a direction that the irradiation light intersects obliquely with the arrangement direction, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal, wherein the irradiation of the irradiation light and the detection of an interruption of the irradiation light are performed successively for the plurality of lead terminals by relatively moving either one of the optical sensor and the lead terminals relative to the other in the arrangement direction, thereby counting the number of the lead terminals.

According to this configuration, the inspection to determine whether or not the lead terminals are acceptable can be performed with high accuracy in an easy and efficient manner even for an electronic apparatus in which the lead terminals are arranged in a plurality of rows.

A lead terminal inspection apparatus according to the present invention is a lead terminal inspection apparatus that performs inspection of the shape condition of lead terminals of an electronic apparatus by irradiating irradiation light from a light emitting unit to the lead terminals and detecting reflected light reflected from the lead terminals with a light receiving unit, the light emitting unit being configured to irradiate irradiation light having a diameter not greater than the width in the irradiation direction of the lead terminals to a detection target tip position of each lead terminal, the light receiving unit being configured to detect reflected light reflected from the lead terminals, the lead terminal inspection apparatus including: an optics moving unit that moves the light emitting unit and the light receiving unit in the arrangement direction of the lead terminals, so that the irradiation of the irradiation light and the detection of the reflected light are performed successively for the plurality of lead terminals; a counting unit that counts the number of the lead terminals by detecting the reflected light; and a comparison/determination unit that determines whether or not the lead terminals are acceptable by comparing the number counted by the counting unit with a predetermined specified number.

According to this configuration, because the light emitting unit that irradiates the irradiation light to the lead terminals, and the light receiving unit that detects the reflected light reflected from the lead terminals are provided, and the number of the lead terminals can be counted based on the reflected light detected by moving the light emitting unit and the light receiving unit in the arrangement direction of the lead terminals, a lead terminal having a defective shape can be detected with high accuracy with a simple movable structure,

Furthermore, a lead terminal inspection apparatus according to the present invention is a lead terminal inspection apparatus that performs inspection of the shape condition of lead terminals of an electronic apparatus by irradiating irradiation light from a light emitting unit to the lead terminals and detecting reflected light reflected from the lead terminals with a light receiving unit, the light emitting unit being configured to irradiate irradiation light having a diameter not greater than the width in the irradiation direction of the lead terminals to a detection target tip position of each lead terminal, the light receiving unit being configured to detect reflected light reflected from the lead terminals, the lead terminal inspection apparatus including: an apparatus moving unit that moves the electronic apparatus in the arrangement direction of the lead terminals, so that the irradiation of the irradiation light and the detection of the reflected light are performed successively for the plurality of lead terminals; a counting unit that counts the number of the lead terminals by detecting the reflected light; and a comparison/determination unit that determines whether or not the lead terminals are acceptable by comparing the number counted by the counting unit with a predetermined specified number.

According to this configuration, because the light emitting unit that irradiates the irradiation light to the lead terminals, and the light receiving unit that detects the reflected light reflected from the lead terminals are provided, and the number of the lead terminals can be counted based on the reflected light detected by moving the electronic apparatus in the arrangement direction of the lead terminals, a lead terminal having a defective shape can be detected with high accuracy with a simple movable structure. Furthermore, because the light emitting unit and the light receiving unit are fixed, the optical paths of the irradiation light and the reflected light can be stabilized, the detection can be effected with high accuracy, and the manufacturing process can be carried out in-line.

Furthermore, in the lead terminal inspection apparatus according to the present invention, the light emitting unit and the light receiving unit are mounted in the same package.

According to this configuration, the structure of the optical sensor can be simplified, and the accuracy can be increased.

Furthermore, a lead terminal inspection apparatus according to the present invention is a lead terminal inspection apparatus including a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal, the lead terminal inspection apparatus including: an optics link moving unit that moves the light emitting unit and the light receiving unit in synchronization with each other in the arrangement direction, so that the irradiation of the irradiation light and the detection of an interruption of the irradiation light are performed successively for the plurality of lead terminals; a counting unit that counts the number of the lead terminals by detecting the interruption of the irradiation light; and a comparison/determination unit that determines whether or not the lead terminals are acceptable by comparing the number counted by the counting unit with a predetermined specified number.

According to this configuration, because the light emitting unit that irradiates the irradiation light to the lead terminals, and the light receiving unit that detects the reflected light reflected from the lead terminals are provided, and the number of the lead terminals can be counted based on the interruptions of the irradiation light detected by moving the light emitting unit and the light receiving unit in the arrangement direction of the lead terminals, a lead terminal having a defective shape can be detected with high accuracy with a simple movable structure. Furthermore, it is only necessary to move the light emitting unit and the light receiving unit of the optical sensor parallel to the arrangement direction of the lead terminals, whereby a highly accurate detection can be achieved with a simple movable structure.

Furthermore, a lead terminal inspection apparatus according to the present invention is a lead terminal inspection apparatus including a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal, the lead terminal inspection apparatus including: an apparatus moving unit that moves the electronic apparatus in the arrangement direction, so that the irradiation of the irradiation light and the detection of an interruption of the irradiation light are performed successively for the plurality of lead terminals; a counting unit that counts the number of the lead terminals by detecting the interruption of the irradiation light; and a comparison/determination unit that determines whether or not the lead terminals are acceptable by comparing the number counted by the counting unit with a predetermined specified number.

According to this configuration, because the light emitting unit that irradiates the irradiation light to the lead terminals, and the light receiving unit that detects the reflected light reflected from the lead terminals are provided, and the number of the lead terminals can be counted based on the interruptions of the irradiation light detected by moving the electronic apparatus in the arrangement direction of the lead terminals, a lead terminal having a defective shape can be detected with high accuracy with a simple movable structure. Furthermore, it is only necessary to move the electronic apparatus linearly in the arrangement direction of the lead terminals, and because the optical sensor is fixed, the path of the irradiation light can be stabilized, achieving a highly accurate detection.

Furthermore, a lead terminal inspection apparatus according to the present invention is a lead terminal inspection apparatus including a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit, the lead terminals being arranged in a plurality of rows, the light emitting unit and the light receiving unit being disposed in a direction that the irradiation light intersects obliquely with the arrangement direction, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal, the lead terminal inspection apparatus including: an apparatus moving unit that moves the electronic apparatus in the arrangement direction, so that the irradiation of the irradiation light and the detection of an interruption of the irradiation light are performed successively for the plurality of lead terminals; a counting unit that counts the number of the lead terminals by detecting the interruption of the irradiation light, and a comparison/determination unit that determines whether or not the lead terminals are acceptable by comparing the number counted by the counting unit with a predetermined specified number.

According to this configuration, the inspection to determine whether or not the lead terminals are acceptable can be performed with high accuracy in an easy and efficient manner even for an electronic apparatus in which the lead terminals are arranged in a plurality of rows.

Furthermore, in the lead terminal inspection apparatus according to the present invention, the electronic apparatus is an electronic tuner.

According to this configuration, it is possible to perform inspection of electronic tuners with good productivity and good efficiency.

As described above, according to the lead terminal inspection method or lead terminal inspection apparatus of the present invention, expensive devices such as a computing device and a velocity control device are unnecessary, and thus it is possible to perform inspection for various lead terminals having different shapes (the arrangement of lead terminals) of electronic apparatuses at a low cost with good productivity.

### BRIEF DESCRIPTION OF THE DRAWINGS

FIG. 1 is a diagram used to illustrate a lead terminal inspection method according to Embodiment 1 of the present invention, and is a perspective view showing a configuration in which an optical sensor is moved while an electronic apparatus is fixed.

FIG. 2 is a diagram used to illustrate a lead terminal inspection method according to Embodiment 1 of the present invention, and is a perspective view showing a configuration in which an electronic apparatus is moved while an optical sensor is fixed.

FIG. 3 is a diagram used to illustrate a lead terminal inspection method according to Embodiment 2 of the present invention, and is a perspective view showing a configuration in which an optical sensor (a light emitting unit and a light receiving unit) is moved while an electronic apparatus is fixed.

FIG. 4 is a diagram used to illustrate a lead terminal inspection method according to Embodiment 2 of the present invention, and is a perspective view showing a configuration in which an electronic apparatus is moved while an optical sensor (a light emitting unit and a light receiving unit) is fixed.

FIG. 5 is a diagram used to illustrate a lead terminal inspection method according to Embodiment 3 of the present invention, and is a perspective view showing a configuration in which an electronic apparatus is moved while an optical sensor (a light emitting unit and a light receiving unit) is fixed.

FIG. 6 is a diagram used to illustrate the lead terminal inspection method according to Embodiment 3 of the present invention, and shows an interruption state of irradiation light.

FIG. 7 is a diagram used to illustrate a lead terminal inspection apparatus according to Embodiment 4 of the present invention, and is a block diagram showing a configuration in which an optical sensor is moved while an electronic apparatus is fixed.

FIG. 8 is a diagram used to illustrate a lead terminal inspection apparatus according to Embodiment 4 of the present invention, and is a block diagram showing a configuration in which an electronic apparatus is moved while an optical sensor is fixed.

FIG. 9 is a diagram used to illustrate a lead terminal inspection apparatus according to Embodiment 5 of the present invention, and is a block diagram showing a configuration in which an optical sensor (a light emitting unit and a light receiving unit) is moved while an electronic apparatus is fixed.

FIG. 10 is a diagram used to illustrate a lead terminal inspection method according to Embodiment 5 of the present invention, and is a perspective view showing a configuration in which an electronic apparatus is moved while an optical sensor (a light emitting unit and a light receiving unit) is fixed.

FIG. 11 is a diagram used to illustrate a relationship between the diameter of irradiation light and a detection target tip position according to Embodiment 7 of the present invention.

FIG. 12 is a diagram illustrating a state in which the lead terminals of an electronic tuner are inspected visually according to the lead terminal inspection method of Conventional Example 1.

FIG. 13 is a diagram illustrating a state in which the lead terminals of an electronic tuner are inspected using a dedicated inspection apparatus according to the lead terminal inspection method (lead terminal inspection apparatus) of Conventional Example 2.

### DETAILED DESCRIPTION OF THE INVENTION

Hereinafter, embodiments of the present invention will be described with reference to the accompanying drawings.

### Embodiment 1

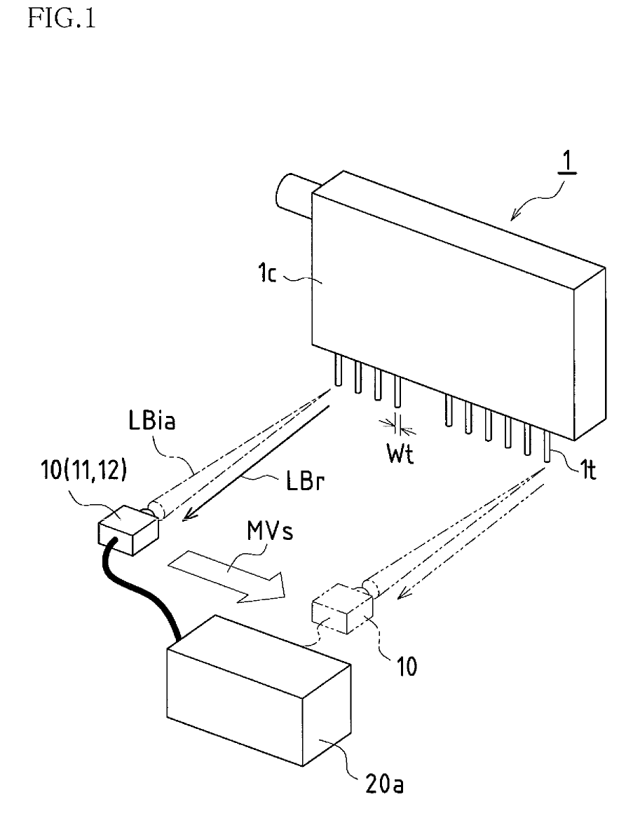

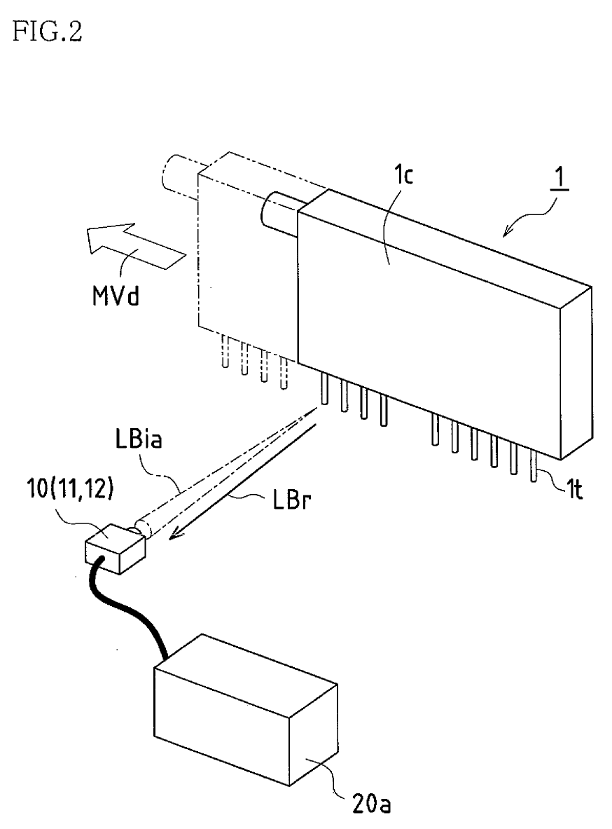

With reference to FIGS. 1 and 2, a lead terminal inspection method according to Embodiment 1 will be described.

FIG. 1 is a diagram used to illustrate the lead terminal inspection method according to Embodiment 1 of the present invention, and is a perspective view showing a configuration in which an optical sensor is moved while an electronic apparatus is fixed.

An electronic tuner 1, which is an electronic apparatus to be inspected, is provided with a housing 1c, and a plurality of lead terminals 1t to be connected to an external wiring board or the like are arranged in a predetermined arrangement direction (usually, linearly, for example) on one face of the housing 1c. It should be noted that the electronic tuner 1 is employed as an example of an electronic apparatus in this application, but the present invention is not limited thereto, and is applicable to various electronic apparatuses in which lead terminals are arranged in a predetermined arrangement direction.

According to the lead terminal inspection method of Embodiment 1, the shape condition of the lead terminals. It is inspected by irradiating irradiation light LBia from a light emitting unit 11 provided in an optical sensor 10 to a lead terminal 1t of the electronic tuner 1, and then detecting reflected light LBr reflected from the lead terminal 1t with a light receiving unit 12 provided in the optical sensor 10.

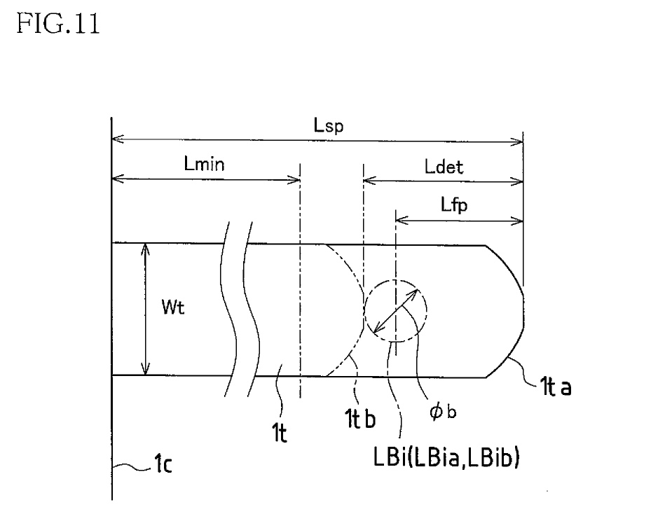

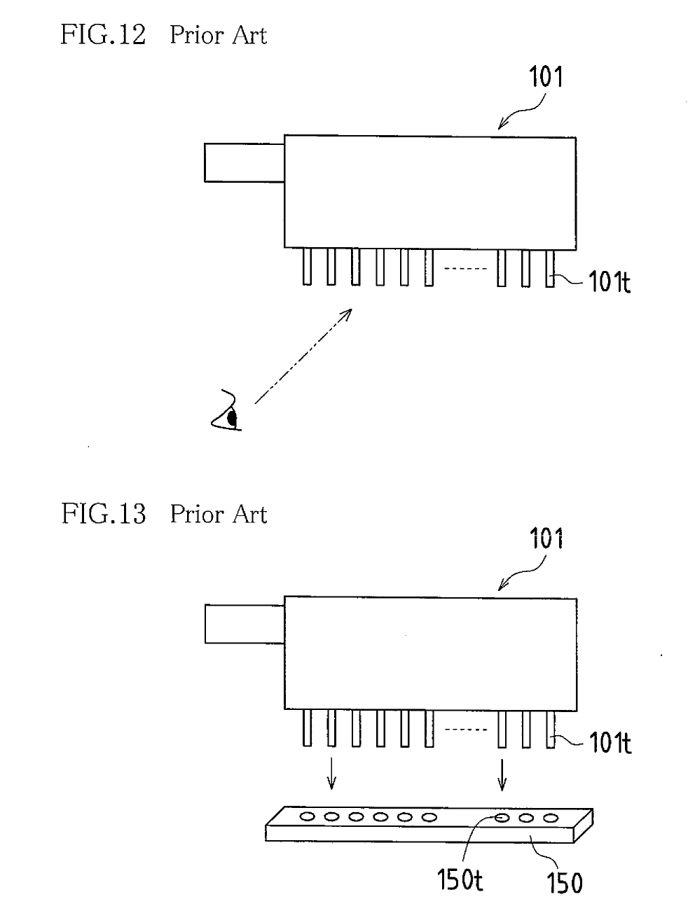

The optical sensor 10 is configured to irradiate the irradiation light LBia having a diameter φb (see FIG. 11) not greater than the width Wt in the irradiation direction of the lead terminal 1t to the detection target tip position Ldet (see FIG. 11) of the lead terminal 1t, and detect the reflected light LBr reflected from the lead terminal 1t. The detection principle will be described in further detail when describing FIG. 11. The irradiation direction is set to a direction that intersects with the arrangement direction of the lead terminals 1t. Considering the detection accuracy, it is desirable that the irradiation direction is set to be perpendicular. However, the irradiation direction is not limited to the perpendicular direction, and may be any direction as long as the reflected light LBr can be detected.

While the electronic tuner 1 is fixed, the optical sensor 10 is moved in a direction parallel to the arrangement direction of the lead terminals 1t (in the sensor moving direction MVs), and the irradiation of the irradiation light LBia and the detection of the reflected light LBr are performed successively for the plurality of lead terminals 1t.

In other words, the number of the reflected lights LBr reflected from the lead terminals 1t is counted by a counting unit 20a, whereby the number of the lead terminals 1t (the normal number of lead terminals 1t) can be obtained. Because lead terminals 1t having defective shapes do not generate reflected light LBr, these lead terminals will not be included in the number of the lead terminals 1t.

According to this embodiment, a lead terminal inspection (to check the shape) can be carried out by counting the number of the lead terminals 1t by irradiating the irradiation light LBia from the optical sensor 10 and detecting the reflected light LBr. It is only necessary to move the optical sensor 10 parallel to the arrangement direction of the lead terminals 1t, whereby it is possible to achieve a highly accurate detection with a simple movable structure.

It is desirable that the optical sensor 10 is moved at a movement pitch that corresponds to the pitch of the lead terminals 1t to be detected. Also, by irradiating the irradiation light LBia (light emission) in conjunction with (in synchronization with) the move, the reflected light LBr can be detected successively. In other words, the irradiation light LBia can be emitted intermittently according to the move. Because the light is emitted intermittently, the power consumption of the light emitting unit can be reduced.

When no reflected light LBr is detected, the lead terminal 1t is not counted by the counting unit 20a, instead, a comparison/determination unit (not shown) determines the number of the lead terminals 1t to be less than the normal number of lead terminals 1t. Thus, the inspection result is obtained that the lead terminals 1t are defective (breakage, length shortage due to intrusion into the housing 1c of the electronic tuner 1, misalignment due to deformation, etc.).

It is also possible that the irradiation light LBia is continuous light. In this case, similar to the case in which the light is emitted intermittently, the reflected light LBr can be detected. In the case of using continuous light, a configuration can be adopted in which the detection is carried out by continuously moving the sensor without setting the movement pitch.

FIG. 2 is a diagram used to illustrate a lead terminal inspection method according to Embodiment 1 of the present invention, and is a perspective view showing a configuration in which an electronic apparatus is moved while an optical sensor is fixed.

The lead terminal inspection method shown in FIG. 2 has a basic configuration identical to that of the lead terminal inspection method shown in FIG. 1, and thus the descriptions will focus primarily on the differences. In the case of FIG. 2, while the optical sensor 10 is fixed, the lead terminals 1t (electronic tuner 1) are moved in the arrangement direction of the lead terminals 1t (in the apparatus moving direction MVd). In this case, similar to the case of FIG. 1, it is possible to detect a lead terminal 1t having a defective shape.

Because the inspection can be carried out while the electronic tuner 1 is being moved, the inspection can be carried out, for example, while the electronic tuner 1 is being conveyed with a conveyer or the like, without having to provide a special inspection process, and the manufacturing process can be carried out in-line.

It is only necessary to move the electronic tuner 1 linearly in the arrangement direction of the lead terminals 1t, and because the optical sensor 10 is fixed, the optical paths of the irradiation light LBia and the reflected light LBr can be stabilized, and thus a highly accurate detection can be achieved.

It is desirable that the electronic tuner 1 is moved at a movement pitch that corresponds to the pitch of the lead terminals 1t to be detected. Also, by irradiating the irradiation light LBia (light emission) in conjunction with the move, the reflected light LBr can be detected successively. In other words, the irradiation light LBia can be emitted intermittently according to the move. Similar to the case of FIG. 1, the irradiation light LBia may be continuous light.

As described above, the lead terminal inspection method according to this embodiment is a lead terminal inspection method in which the shape condition of the lead terminals 1t is inspected by irradiating the irradiation light LBia from the optical sensor 10 to the lead terminals 1t of the electronic tuner 1, and detecting the reflected light LBr reflected from the lead terminals 1t by the optical sensor 10. Furthermore, the optical sensor 10 is configured to irradiate the irradiation light LBia having a diameter φb not greater than the width Wt in the irradiation direction of the lead terminals 1t to the detection target tip position Ldet of the lead terminals 1t, and detect the reflected light LBr reflected from the lead terminals 1t. According to this lead terminal inspection method, the number of lead terminals 1t is counted by performing the irradiation of the irradiation light LBia and the detection of the reflected light LBr successively for a plurality of lead terminals 1t by relatively moving either one of the optical sensor 10 and the lead terminals 1t (electronic tuner 1) relative to the other in the arrangement direction of the lead terminals 1t (in a direction parallel to the arrangement direction).

According to this configuration, because the reflected light LBr generated according to the shape condition at the detection target tip position Ldet of the lead terminals 1t is detected, and the number of lead terminals 1t is counted based on the detection of the reflected light LBr, the inspection to determine whether or not the lead terminals 1t are acceptable can be performed with high accuracy in an easy and efficient manner by non-detecting reflected light LBr caused by a lead terminal 1t having a defective shape (breakage, deformation, length shortage due to intrusion into the housing 1c of the electronic tuner 1, misalignment due to deformation, etc.).

According to this embodiment, the electronic tuner 1 as an electronic apparatus is inspected, and therefore the lead terminals of the electronic tuner 1 can be performed in an easy and efficient manner; accordingly, a low-cost inspection with good productivity can be achieved.

### Embodiment 2

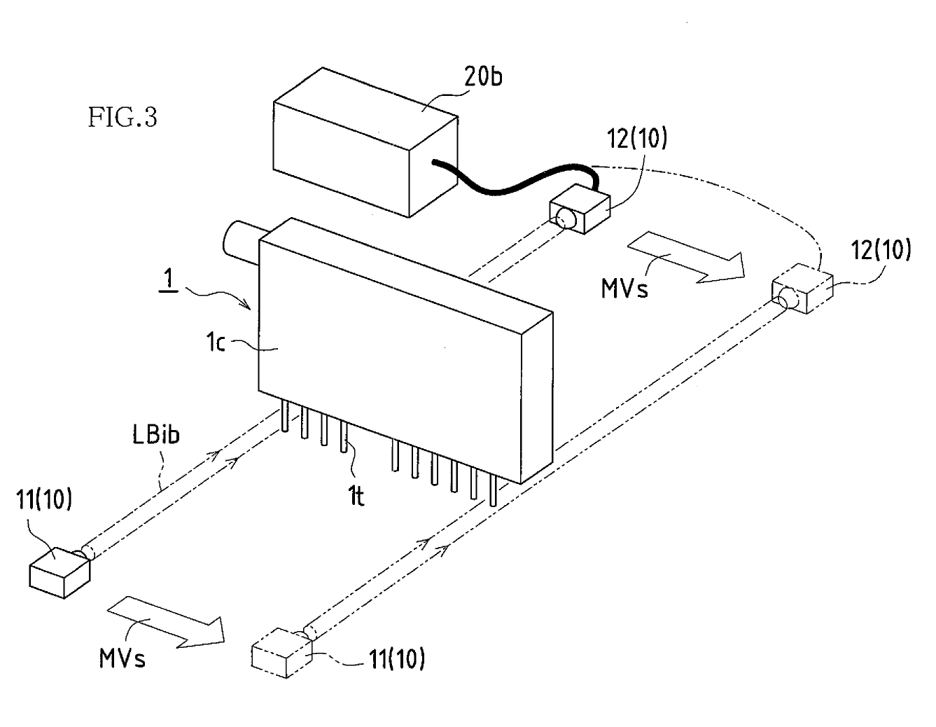

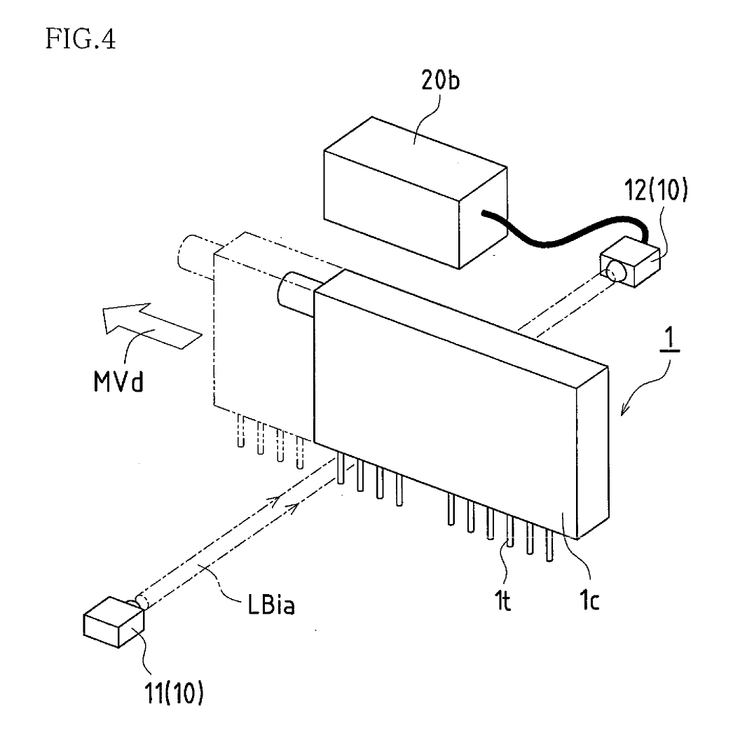

With reference to FIGS. 3 and 4, a lead terminal inspection method according to Embodiment 2 will be described.

FIG. 3 is a diagram used to illustrate a lead terminal inspection method according to Embodiment 2 of the present invention, and is a perspective view showing a configuration in which an optical sensor (a light emitting unit and a light receiving unit) is moved while an electronic apparatus is fixed.

In the lead terminal inspection method according to this embodiment, a light emitting unit 11 of an optical sensor 10 and a light receiving unit 12 of the optical sensor 10 are disposed in a direction that intersects with the arrangement direction of the lead terminals 1t of an electronic tuner 1 such that the light emitting unit 11 and the light receiving unit 12 face each other, and the shape condition of the lead terminals 1t is inspected by irradiating irradiation light LBib from the light emitting unit 11 to a lead terminal 1t, and detecting the irradiation light LBib with the light receiving unit 12.

The light emitting unit 11 is configured to irradiate irradiation light LBib having a diameter φb (see FIG. 11) not greater than the width Wt in the irradiation direction of the lead terminals 1t to the detection target tip position Ldet of a lead terminal 1t (see FIG. 11). The light receiving unit 12 is configured to detect an interruption of the irradiation light LBib caused by the lead terminal 1t. The detection principle will be described in further detail when describing FIG. 11. The irradiation direction preferably is perpendicular considering the detection accuracy, but the irradiation direction is not limited to the perpendicular direction as long as an interruption of the irradiation light LBib can be detected (see Embodiment 3).

While the electronic tuner 1 is fixed, the light emitting unit 11 and the light receiving unit 12 (the optical sensor 10) are moved (in the sensor moving direction MVs) in synchronization with each other in a direction (arrangement direction) parallel to the arrangement direction of the lead terminals 1t such that the irradiation of the irradiation light LBib and the detection of the irradiation light LBib are performed successively for a plurality of lead terminals 1t. In other words, the number of interruptions of the irradiation light LBib caused by the lead terminals 1t is counted by the counting unit 20b, whereby the number of the lead terminals 1t (the normal number of lead terminals 1t) can be obtained. Furthermore, lead terminals 1t having defective shapes do not cause an interruption of the irradiation light LBib, and thus these lead terminals 1t will not be included in the number of the lead terminals 1t.

The counting unit 20a described in Embodiment 1 yields the number of the lead terminals 1t (the normal number of lead terminals 1t) by counting the number of the reflected lights LBr. Unlike Embodiment 1, the counting unit 20b yields the number of the lead terminals 1t (the normal number of lead terminals 1t) by counting the number of interruptions of the irradiation light LBib.

According to this embodiment, the inspection of lead terminals (to check the shape) can be carried out by counting the number of the lead terminals 1t by performing the irradiation of the irradiation light LBib and the detection of an interruption of the irradiation light LBib with the optical sensor 10 (the light emitting unit 11 and the light receiving unit 12). It is only necessary to move the light emitting unit 11 and the light receiving unit 12 of the optical sensor 10 parallel to the arrangement direction of the lead terminals 1t, whereby a highly accurate detection can be achieved with a simple movable structure.

It is desirable that the optical sensor 10 is moved at a pitch that corresponds to the lead terminals 1t to be detected. Furthermore, the detection of an interruption of the irradiation light LBib can be performed successively by irradiating (emitting) the irradiation light LBib in conjunction with (in synchronization with) the move. In other words, the irradiation light LBib can be emitted intermittently according to the move.

When no interruption of the irradiation light LBib is detected, the lead terminal 1t is not counted by the counting unit 20a, instead, a comparison/determination unit (not shown) determines the number of the lead terminals 1t to be less than the normal number of lead terminals 1t. Thus, the inspection result is obtained that the lead terminals 1t are defective (breakage, length shortage due to intrusion into the housing 1c of the electronic tuner 1, misalignment due to deformation, etc.).

The irradiation light LBib may be continuous light. In this case, the interruptions of the irradiation light LBib can be detected with still higher accuracy. Furthermore, abnormal light emission of the light emitting unit 11 can be detected at an early stage. For this reason, it is desirable to use continuous light. In the case of using continuous light, a configuration can be adopted in which the detection is carried out by continuously moving the sensor without setting the movement pitch.

FIG. 4 is a diagram used to illustrate a lead terminal inspection method according to Embodiment 2 of the present invention, and is a perspective view showing a configuration in which an electronic apparatus is moved while an optical sensor (a light emitting unit and a light receiving unit) is fixed.

The lead terminal inspection method shown in FIG. 4 has a basic configuration identical to that of the lead terminal inspection method shown in FIG. 3, and thus the descriptions will focus primarily on the differences. In the case of FIG. 4, while the optical sensor 10 (the light emitting unit 11 and the light receiving unit 12) is fixed, the lead terminals 1t (electronic tuner 1) are moved in the arrangement direction (in the apparatus moving direction MVd) of the lead terminals 1t. In this case, similar to the case of FIG. 3, it is possible to detect a lead terminal 1t having a defective shape.

Because the inspection can be carried out while the electronic tuner 1 is being moved, the inspection can be carried out, for example, while the electronic tuner 1 is being conveyed with a conveyer or the like, without having to provide a special inspection process, and the manufacturing process can be carried out in-line.

It is only necessary to move the electronic tuner 1 linearly in the arrangement direction of the lead terminals 1t, and because the optical sensor 10 (the light emitting unit 11 and the light receiving unit 12) is fixed, the optical path of the irradiation light LBib can be stabilized, and thus a highly accurate detection can be achieved.

It is desirable that the optical sensor 10 is moved at a movement pitch that corresponds to the pitch of the lead terminals 1t to be detected. Also, by irradiating the irradiation light LBib (light emission) in conjunction with the move, an interruption of the irradiation light LBib can be detected successively. In other words, the irradiation light LBia can be emitted intermittently according to the move. Similar to the case of FIG. 3, the irradiation light LBia may be continuous light.

As described above, the lead terminal inspection method according to this embodiment is a lead terminal inspection method in which the light emitting unit 11 of the optical sensor 10 and the light receiving unit 12 of the optical sensor 10 are disposed in a direction that intersects with the arrangement direction of the lead terminals 1t of the electronic tuner 1 such that the light emitting unit 11 and the light receiving unit 12 face each other, and the shape condition of the lead terminals 1t is inspected by irradiating the irradiation light LBib from the light emitting unit 11 to the lead terminals, and detecting the irradiation light LBib with the light receiving unit 12. Furthermore, the light emitting unit 11 is configured to irradiate irradiation light LBib having a diameter φb not greater than the width Wt in the irradiation direction of the lead terminals 1t to the detection target tip position Ldet of a lead terminal 1t. The light receiving unit 12 is configured to detect an interruption of the irradiation light LBib caused by the lead terminal 1t. According to this lead terminal inspection method, the number of lead terminals 1t is counted by performing the irradiation of the irradiation light LBib and the detection of the irradiation light LBib successively for a plurality of lead terminals 1t by relatively moving either one of the optical sensor 10 (the light emitting unit 11 and the light receiving unit 12) and the lead terminals 1t relative to the other in the arrangement direction of the lead terminals 1t (a direction parallel to the arrangement direction).

According to this configuration, because an interruption of the irradiation light LBib generated according to the shape condition at the detection target tip position Ldet of normal lead terminals 1t is detected, and the number of lead terminals 1t is counted based on the detection of the interruptions of the irradiation light LBib, the inspection to determine whether or not the lead terminals 1t are acceptable can be performed with high accuracy in an easy and efficient manner by identifying a lead terminal 1t having a defective shape (breakage, deformation, length shortage due to intrusion into the housing 1c of the electronic tuner 1, misalignment due to deformation, etc.).

### Embodiment 3

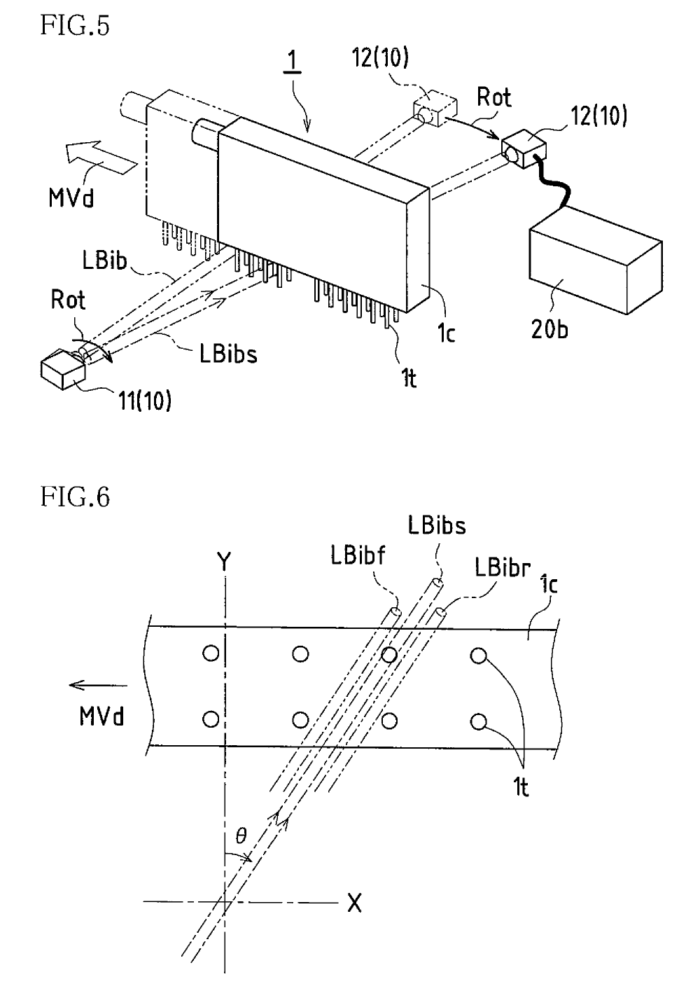

With reference to FIGS. 5 and 6, a lead terminal inspection method according to Embodiment 3 will be described.

FIG. 5 is a diagram used to illustrate a lead terminal inspection method according to Embodiment 3 of the present invention, and is a perspective view showing a configuration in which an electronic apparatus is moved while an optical sensor (a light emitting unit and a light receiving unit) is fixed. Similarly, FIG. 6 is a diagram used to illustrate an interruption state of irradiation light.

The lead terminal inspection method according to Embodiment 3 is obtained by changing the arrangement of the optical sensor 10 (the light emitting unit 11 and the light receiving unit 12) of Embodiment 2. The basic configuration is identical to that of Embodiment 2, and thus the same reference numerals are employed, and the descriptions will focus primarily on the differences.

In an electronic tuner 1 as an inspection object of this embodiment, the lead terminals 1t are arranged in a plurality of rows. If irradiation light LBib is irradiated from a direction orthogonal to the arrangement direction of the lead terminals 1t, because a plurality of lead terminals 1t are present on the optical path, it is difficult to perform detection by distinguishing the lead terminals 1t arranged in a plurality of rows. In order to solve this problem, according to this embodiment, an optical sensor 10 is disposed in a direction that irradiation light LBibs is irradiated at an oblique angle θ relative to a direction (perpendicularly intersecting axis Y) perpendicular to the arrangement direction of the lead terminals 1t.

More specifically, according to this embodiment, the optical sensor 10 is shifted (rotational shift) in a direction indicated by the arrow Rot such that the optical sensor 10 (the light emitting unit 11 and the light receiving unit 12) is disposed in a direction that is oblique to the arrangement direction of the lead terminals 1t (the parallel direction X parallel to the arrangement direction: arrangement direction). Accordingly, a configuration is adopted in which the optical path of the irradiation light LBib irradiated in the direction of the perpendicularly intersecting axis Y is changed to the optical path of the irradiation light LBibs.

When the electronic tuner 1 (the lead terminals 1t) is moved in the apparatus moving direction MVd, the irradiation lights LBibf and LBibr that are, for example, around the irradiation light LBibs are not interrupted by a lead terminal 1t of any row, and only the irradiation light LBibs is interrupted by a lead terminal 1t of one row (see FIG. 6). In other words, the irradiation light LBibs serves as irradiation light that corresponds to each lead terminal 1t of the plurality of rows, and it is therefore possible to obtain an effect similar to the case where the lead terminals 1t are arranged in a single row even when the electronic tuner 1 in which the lead terminals 1t are arranged in a plurality of rows is used.

Although FIGS. 5 and 6 illustrate the case where the electronic tuner 1 is moved as shown in FIG. 4, it is also possible to adopt a configuration in which the optical sensor 10 is moved as shown in FIG. 3. However, in order to move the optical sensor 10 in a parallel manner while maintaining the oblique state, the region necessary for the move of the optical sensor 10 increases, and it is therefore desirable that the electronic apparatus is moved linearly in the arrangement direction of the lead terminals 1t while the optical sensor 10 is fixed.

As described above, the lead terminal inspection method according to this embodiment is a lead terminal 1t inspection method in which the light emitting unit 11 of the optical sensor 10 and the light receiving unit 12 of the optical sensor 10 are disposed in a direction that intersects with the arrangement direction of the lead terminals 1t of the electronic tuner 1 such that the light emitting unit 11 and the light receiving unit 12 face each other, and the shape condition of the lead terminals 1t is inspected by irradiating the irradiation light LBib from the light emitting unit 11 to the lead terminals 1t, and detecting the irradiation light LBib with the light receiving unit 12. Furthermore, a configuration is adopted in which the lead terminals 1t are arranged in a plurality of rows, the optical sensor 10 (the light emitting unit 11 and the light receiving unit 12) is disposed in a direction that the optical path of the irradiation light LBib intersects obliquely with the arrangement direction of the lead terminals 1t, the light emitting unit 11 irradiates irradiation light LBib having a diameter not greater than the width Wt in the irradiation direction of the lead terminals 1t to the detection target tip position Ldet of a lead terminal 1t, and the light receiving unit 12 detects an interruption of the irradiation light LBib caused by the lead terminal 1t. According to this lead terminal inspection method, the irradiation of the irradiation light LBib and the detection of the irradiation light LBib are performed successively for a plurality of lead terminals 1t by relatively moving either one of the optical sensor 10 (the light emitting unit 11 and the light receiving unit 12) and the lead terminals 1t relative to the other in the arrangement direction (a direction parallel to the arrangement direction: parallel axis X direction), thereby counting the number of the lead terminals 1t.

According to this configuration, the inspection to determine whether or not the lead terminals 1t are acceptable can be performed with high accuracy in an easy and efficient manner even for an electronic tuner 1 in which the lead terminals 1t are arranged in a plurality of rows.

### Embodiment 4

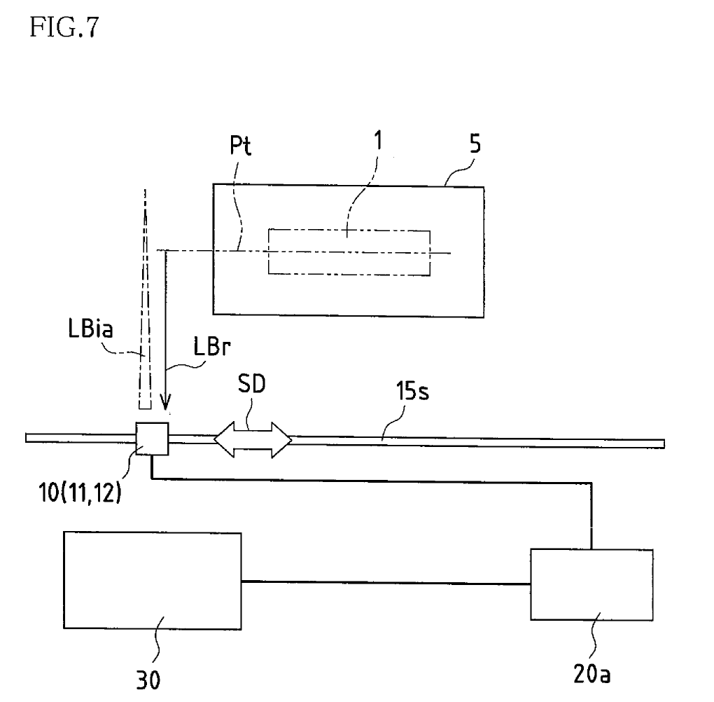

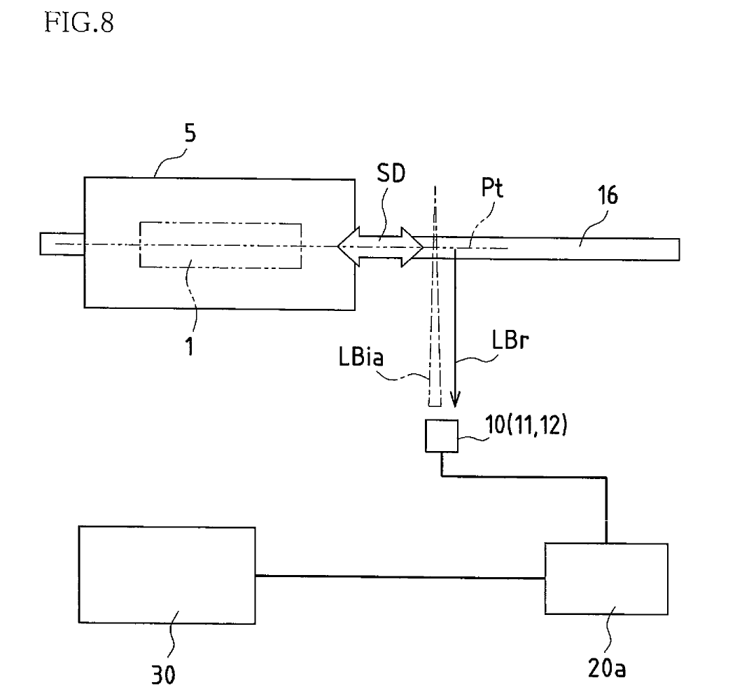

With reference to FIGS. 7 and 8, a lead terminal inspection apparatus according to Embodiment 4 will be described.

FIG. 7 is a diagram used to illustrate a lead terminal inspection apparatus according to Embodiment 4 of the present invention, and is a block diagram showing a configuration in which an optical sensor is moved while an electronic apparatus is fixed.

The basic configuration is identical to that of Embodiment 1 shown in FIG. 1, and thus the same reference numerals are employed where appropriate, and the descriptions will focus primarily on the differences.

In the lead terminal inspection apparatus according to this embodiment, an electronic tuner 1 is placed and fixed on an electronic apparatus holding table 5. And, an optics moving unit 15s for moving (as indicated by arrow SD) an optical sensor 10 (a light emitting unit 11 and a light receiving unit 12) is disposed in a direction parallel to the terminal arrangement position Pt (arrangement direction) of the lead terminals 1t such that the optics moving unit 15s corresponds to the electronic apparatus holding table 5. The optics moving unit 15s can be configured easily by utilizing an appropriate mechanism such as a rack and pinion, a manipulator base, or a hydraulic or pneumatic cylinder.

Furthermore, it is desirable that in the optical sensor 10, the light emitting unit 11 and the light receiving unit 12 are mounted in the same package. According to this configuration, the structure of the optical sensor 10 can be simplified, and the accuracy can be increased. With this combined structure, the control of the movement can be made easy and highly accurate. As the light emitting unit 11, a semiconductor light emitting diode or semiconductor laser can be used. As the light receiving unit 12, a photodiode or phototransistor can be used. By using these semiconductor elements, it is possible to configure an optical sensor 10 in which the size reduction is achieved and a highly accurate detection is effected.

By moving the optical sensor 10 using the optics moving unit 15s, a configuration is adopted in which the irradiation of the irradiation light LBia and the detection of the reflected light LBr reflected from the terminal arrangement position Pt are performed successively for a plurality of lead terminals 1t by moving the optical sensor 10 (the light emitting unit 11 and the light receiving unit 12) in a direction parallel to the arrangement direction of the lead terminals 1t (terminal arrangement position Pt).

Furthermore, this lead terminal inspection apparatus is provided with a counting unit 20a that counts the number of the lead terminals 1t by detecting the reflected light LBr, and a comparison/determination unit 30 that determines whether or not the lead terminals are acceptable by comparing the number counted by the counting unit 20a with a predetermined specified number (the normal number of lead terminals). The counting unit 20a and the comparison/determination unit 30 can be configured by using an appropriate computation circuit.

As described above, the lead terminal inspection apparatus according to this embodiment is an apparatus that performs inspection of the shape condition of the lead terminals 1t by irradiating the irradiation light LBia from the light emitting unit 11 to the lead terminals 1t of the electronic tuner 1, and detecting the reflected light LBr reflected from the lead terminals 1t with the light receiving unit 12. Furthermore, the light emitting unit 11 is configured to irradiate irradiation light LBia having a diameter φb not greater than the width Wt in the irradiation direction of the lead terminals 1t to the detection target tip position Ldet of a lead terminal 1t. The light receiving unit 12 is configured to detect the reflected light LBr reflected from the lead terminal 1t. This lead terminal inspection apparatus is provided with: an optics moving unit 15s that moves (as indicated by arrow SD) the light emitting unit 11 and the light receiving unit 12 in the arrangement direction of the lead terminals 1t (terminal arrangement position Pt: a direction parallel to the arrangement direction) so that the irradiation of the irradiation light LBia and the detection of the reflected light LBr are performed successively for the plurality of lead terminals 1t; a counting unit 20a that counts the number of the lead terminals 1t by detecting the reflected light LBr; and a comparison/determination unit 30 that determines whether or not the lead terminals are acceptable by comparing the number counted by the counting unit 20a with a predetermined specified number.

According to this configuration, because the reflected light LBr generated according to the shape condition at the detection target tip position Ldet of the lead terminals 1t is detected, and the number of lead terminals 1t is counted based on the detection of the reflected light LBr, the inspection to determine whether or not the lead terminals 1t are acceptable can be performed with high accuracy in an easy and efficient manner by non-detecting the reflected light LBr caused by a lead terminal 1t having a defective shape (breakage, deformation, length shortage due to intrusion into the housing 1c of the electronic tuner 1, misalignment due to deformation, etc.). Furthermore, it is only necessary to move the optical sensor 10 parallel to the arrangement direction of the lead terminals 1t, and it is therefore possible to achieve a highly accurate detection with a simple movable structure.

FIG. 8 is a diagram used to illustrate a lead terminal inspection apparatus according to Embodiment 4 of the present invention, and is a block diagram showing a configuration in which an electronic apparatus is moved while an optical sensor is fixed.

The basic configuration is identical to that of Embodiment 1 shown in FIG. 2, and thus the same reference numerals are employed where appropriate, and the descriptions will focus primarily on the differences. Similarly, the basic configuration of the lead terminal inspection apparatus shown in FIG. 8 is identical to that of the lead terminal inspection apparatus shown in FIG. 7 except for the moving mechanism, and thus the descriptions will focus primarily on the differences.

In the lead terminal inspection apparatus according to this embodiment, a configuration is adopted in which while an optical sensor 10 is fixed, an electronic tuner 1 placed on an electronic apparatus holding table 5 is moved by an apparatus moving unit 16. More specifically, in this embodiment, an apparatus moving unit 16 is provided that moves (as indicated by arrow SD) the electronic tuner 1 in the arrangement direction of the lead terminals 1t (terminal arrangement position Pt) so as to perform the irradiation of the irradiation light LBia and the detection of the reflected light LBr successively for a plurality of the lead terminals 1t. Similar to the optics moving unit 15s, the apparatus moving unit 16 can be configured easily by utilizing an appropriate mechanism such as a rack and pinion, a manipulator base, or a hydraulic or pneumatic cylinder.

Furthermore, the lead terminal inspection apparatus according to this embodiment is an apparatus that performs inspection of the shape condition of the lead terminals by irradiating the irradiation light LBia from the light emitting unit 11 to the lead terminals 1t of an electronic tuner 1, and detecting the reflected light LBr reflected from the lead terminals 1t with the light receiving unit 12. Furthermore, light emitting unit 11 is configured to irradiate the irradiation light LBia having a diameter φb not greater than the width Wt in the irradiation direction of the lead terminals 1t to the detection target tip position Ldet of the lead terminals 1t. The light receiving unit 12 is configured to detect the reflected light LBr reflected from the lead terminals 1t. This lead terminal inspection apparatus is proved with: an apparatus moving unit 16 that moves (as indicated by arrow SD) the electronic tuner 1 in the arrangement direction of the lead terminals 1t (terminal arrangement position Pt) so as to perform the irradiation of the irradiation light LBia and the detection of the reflected light LBr successively for a plurality of lead terminals; a counting unit 20a that counts the number of the lead terminals 1t by detecting the reflected light LBr; and a comparison/determination unit 30 that determines whether or not the lead terminals are acceptable by comparing the number counted by the counting unit 20a with a predetermined specified number.

According to this configuration it is only necessary to move the electronic apparatus holding table 5 in the arrangement direction of the lead terminals 1t, and move the electronic tuner 1 linearly in the arrangement direction of the lead terminals 1t (terminal arrangement position Pt), and because the optical sensor 10 is fixed, the optical paths of the irradiation light LBia and the reflected light LBr can be stabilized, achieving a highly accurate detection. Furthermore, the manufacturing process can be carried out in-line.

According to this embodiment, the electronic tuner 1 as an electronic apparatus is inspected, and it is therefore possible to perform inspection of the lead terminals 1t of the electronic tuner 1 in an easy and efficient manner; accordingly, a low-cost inspection with good productivity can be achieved.

### Embodiment 5

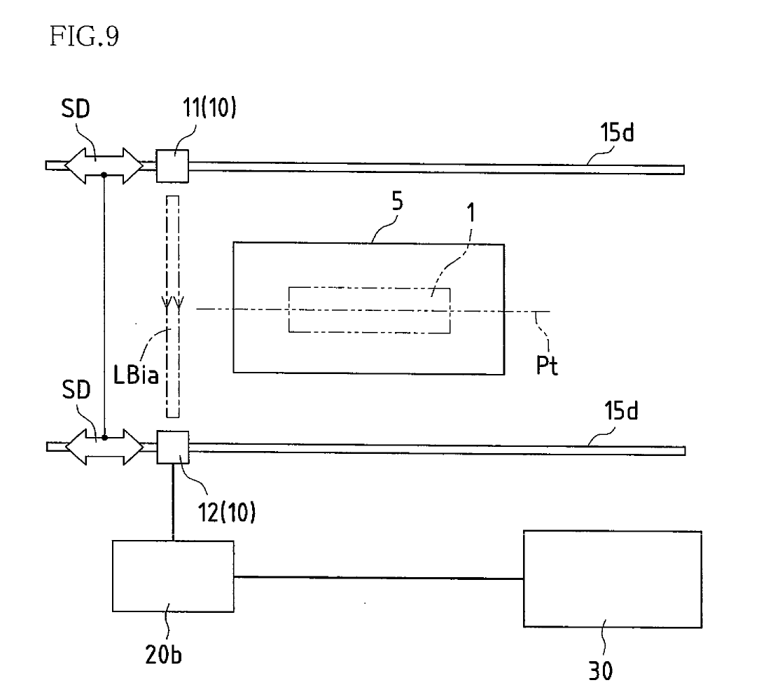

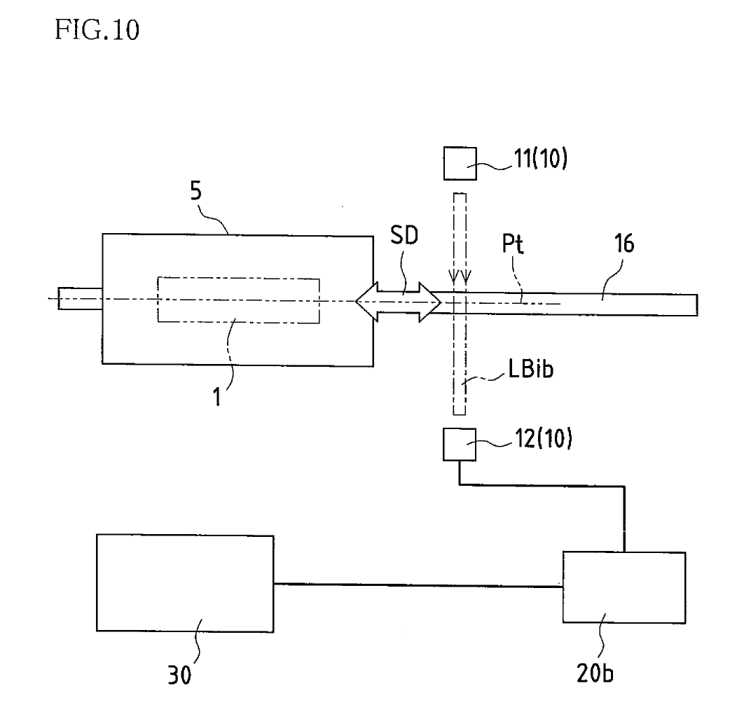

With reference to FIGS. 9 and 10, a lead terminal inspection apparatus according to Embodiment 5 will be described.

FIG. 9 is a diagram used to illustrate a lead terminal inspection apparatus according to Embodiment 5 of the present invention, and is a block diagram showing a configuration in which an optical sensor (a light emitting unit and a light receiving unit) is moved while an electronic apparatus is fixed.

The basic configuration is identical to that of Embodiment 2 shown in FIG. 3, and thus the same reference numerals are employed where appropriate, and the descriptions will focus primarily on the differences.

In the lead terminal inspection apparatus according to this embodiment, an electronic tuner 1 is placed and fixed on an electronic apparatus holding table 5. And, an optics link moving unit 15d for moving (as indicated by arrows SD) the light emitting unit 11 and the light receiving unit 12(the optical sensor 10) in synchronization with each other is disposed in a direction parallel to the terminal arrangement position Pt (arrangement direction) of the lead terminals 1t such that the optics link moving unit; 15d corresponds to the electronic apparatus holding table 5. The optics link moving unit 15d can be configured to be identical to the optics moving unit 15s, and is configured to move the light emitting unit 11 and the light receiving unit 12 in synchronization with each other.

By moving the optical sensor 10 (the light emitting unit 11 and the light receiving unit 12) using the optics link moving unit 15d, a configuration is adopted in which the irradiation of the irradiation light LBib and the detection of the irradiation light LBib are performed successively for a plurality of lead terminals by moving the light emitting unit 11 and the light receiving unit 12 in a direction parallel to the arrangement direction of the lead terminals 1t (terminal arrangement position Pt).

Furthermore, this lead terminal inspection apparatus is provided with a counting unit 20b that counts the number of the lead terminals 1t by detecting the interruptions of the irradiation light LBib, and a comparison/determination unit 30 that determines whether or not the lead terminals are acceptable by comparing the number counted by the counting unit 20b with a predetermined specified number (the normal number of lead terminals). Similar to the counting unit 20a, the counting unit 20b can be configured by using an appropriate computation circuit.

As described above, the lend terminal inspection apparatus according to this embodiment is a lead terminal inspection apparatus that is provided with the light emitting unit 11 disposed in a direction that intersects with the arrangement direction (terminal arrangement position Pt) of the lead terminals 1t of the electronic tuner 1, and the light receiving unit 12 disposed such that the light receiving unit 12 faces the light emitting unit 11, and detects the shape condition of the lead terminals 1t by irradiating the irradiation light LBib from the light emitting unit 11 to the lead terminals 1t and detecting the irradiation light LBib with the light receiving unit 12. The light emitting unit 11 is configured to irradiate irradiation light LBib having a diameter φb not greater than the width Wt in the irradiation direction of the lead terminals 1t to the detection target tip position Ldet of a lead terminal 1t. The light receiving unit 12 is configured to detect an interruption of the irradiation light LBib caused by the lead terminal 1t. This lead terminal inspection apparatus is provided with the optics link moving unit 15d that moves (as indicated by arrow SD) the light emitting unit 11 and the light receiving unit 12 in synchronization with each other in the arrangement direction (terminal arrangement position Pt: a direction parallel to the arrangement direction) so that the irradiation of the irradiation light LBib and the detection of the irradiation light LBib are performed successively for a plurality of lead terminals 1t; a counting unit 20b that counts the number of the lead terminals 1t by detecting the interruption of the irradiation light LBib; and a comparison/determination unit 30 that determines whether or not the lead terminals are acceptable by comparing the number counted by the counting unit 2b with a predetermined specified number.

According to this configuration, because an interruption of the irradiation light LBib generated according to the shape condition at the detection target tip position Ldet of normal lead terminals 1t is detected, and the number of lead terminals 1t is counted based on the detection of the whether or not the lead terminals 1t are acceptable can be performed with high accuracy in an easy and efficient manner by identifying a lead terminal 1t having a defective shape (breakage, deformation, length shortage due to intrusion into the housing 1c of the electronic tuner 1, misalignment due to deformation, etc.). Furthermore, it is only necessary to move the light emitting unit 11 and the light receiving unit 12 of the optical sensor 10 parallel to the arrangement direction of the lead terminals 1t, whereby it is possible to achieve a highly accurate detection with a simple movable structure.

FIG. 10 is a diagram used to illustrate a lead terminal inspection method according to Embodiment 5 of the present invention, and is a perspective view showing a configuration in which an electronic apparatus is moved while an optical sensor (a light emitting unit and a light receiving unit) is fixed.

The basic configuration is identical to that of Embodiment 2 shown in FIG. 4, and thus the same reference numerals are employed where appropriate, and the descriptions will focus primarily on the differences. Similarly, the basic configuration of the lead terminal inspection apparatus shown in FIG. 10 is identical to that of the lead terminal inspection apparatus shown in FIG. 9 except for the moving mechanism, and thus the descriptions will focus primarily on the differences.

In the lead terminal inspection apparatus according to this embodiment, a configuration is adopted in which a light emitting unit 11 and a light receiving unit 12 (an optical sensor 10) are fixed, and an electronic tuner 1 placed on an electronic apparatus holding table 5 is moved by an apparatus moving unit 16. In other words, a configuration is adopted in which the irradiation of the irradiation light LBia and the detection of an interruption of the irradiation light LBib are performed successively for a plurality of lead terminals by moving (as indicated by arrow SD) the electronic tuner 1 in the arrangement direction of the lend terminals 1t (terminal arrangement position Pt). The apparatus moving unit 16 is identical to the apparatus moving unit 16 shown in FIG. 8.

As described above, the lead terminal inspection apparatus according to this embodiment is a lead terminal inspection apparatus that is provided with the light emitting unit 11 disposed in a direction that intersects with the arrangement direction of the lead terminals 1t of the electronic tuner 1, and the light receiving unit 12 disposed such that the light receiving unit 12 faces the light emitting unit 11, and performs inspection of the shape condition of the lead terminals 1t by irradiating the irradiation light LBib from the light emitting unit 11 to the lead terminals 1t, and detecting the irradiation light LBib with the light receiving unit 12. Furthermore, the light emitting unit 11 is configured to irradiate irradiation light LBib having a diameter φb not greater than the width Wt in the irradiation direction of the lead terminals 1t to the detection target tip position Ldet of a lead terminal 1t. The light receiving unit 12 is configured to detect an interruption of the irradiation light LBib caused by the lead terminal 1t. This lead terminal inspection apparatus is provided with: the apparatus moving unit 16 that moves the electronic tuner 1 in the arrangement direction (terminal arrangement position Pt) so that the irradiation of the irradiation light LBib and the detection of the irradiation light LBib are preformed successively for a plurality of lead terminals 1t; a counting unit 20b that counts the number of the lead terminals 1t by detecting the interruption of the irradiation light LBib; and a comparison/determination unit 30 that determines whether or not the lead terminals are acceptable by comparing the number counted by the counting unit 20b with a predetermined specified number.

According to this configuration, it is only necessary to move the electronic apparatus holding table 5 in the arrangement direction of the lead terminals 1t, and move (as indicated by arrow SD) the electronic tuner 1 linearly in the arrangement direction of the lead terminals 1t (terminal arrangement position Pt), and because the optical sensor 10 is fixed, the optical paths of the irradiation light LBib and the reflected light LBr can be stabilized, and thus a highly accurate detection can be achieved. Furthermore, the manufacturing process can be carried out in-line.

### Embodiment 6

The lead terminal inspection apparatus according to Embodiment 6 (not shown) has a configuration corresponding to that of Embodiment 3 (FIG. 5). More specifically, in the lead terminal inspection apparatus according to this embodiment, an optical sensor 10 (a light emitting unit 11 and a light receiving unit 12) is disposed in a direction that irradiation light LBib intersects obliquely with the arrangement direction of the lead terminals 1t of an electronic tuner 1.

Also, Embodiment 6 is identical to Embodiment 5 (FIGS. 9 and FIG. 10) except that the light emitting unit 11 and the light receiving unit 12 are disposed in a direction oblique to the arrangement direction of the lead terminals 1t, and thus the same reference numerals are employed where appropriate, and the descriptions will focus primarily on the differences. In other words, the moving mechanism can be a mechanism in which the optical sensor 10 is moved while the electronic tuner 1 is fixed, or a mechanism in which the electronic tuner 1 is moved while the optical sensor 10 is fixed. However, similar to the case of Embodiment 3, it is desirable that the electronic tuner 1 is moved linearly in the arrangement direction of the lead terminals 1t while the optical sensor 10 is fixed.

Accordingly, the lead terminal inspection apparatus according to this embodiment (not shown) is an apparatus that is provided with the light emitting unit 11 disposed in a direction that intersects with the arrangement direction (terminal arrangement position Pt) of the lead terminals 1t of the electronic tuner 1, and the light receiving unit 12 disposed such that the light receiving unit 12 faces the light emitting unit 11, and performs inspection of the shape condition of the lead terminals 1t by irradiating the irradiation light LBib from the light emitting unit 11 to the lead terminals 1t and detecting the irradiation light LBib to the light receiving unit 12. Furthermore, the lead terminals 1t are arranged in a plurality of rows. The light emitting unit 11 and the light receiving unit 12 are disposed in a direction that the irradiation light LBib intersects obliquely with the arrangement direction (terminal arrangement position Pt). The light emitting unit 11 is configured to irradiate irradiation light LBib having a diameter φb not greater than the width Wt in the irradiation direction of the lead terminals 1t to the detection target tip position Ldet of a lead terminal 1t. The light receiving unit 12 is configured to detect an interruption of the irradiation light LBib caused by the lead terminal 1t. This lead terminal inspection apparatus is provided with: the apparatus moving unit 16 that moves (as indicated by arrow SD) the electronic tuner 1 in the arrangement direction (terminal arrangement position Pt) so that the irradiation of the irradiation light LBib and the detection of the irradiation light LBib are preformed successively for a plurality of lead terminals 1t; a counting unit 20b that counts the number of the lead terminals 1t by detecting the interruption of the irradiation light LBib; and a comparison/determination unit 30 that determines whether or not the lead terminals are acceptable by comparing the number counted by the counting unit 20b with a predetermined specified number.

According to this configuration, the inspection to determine whether or not the lead terminals 1t are acceptable can be performed with high accuracy in an easy and efficient manner even for an electronic tuner 1 in which the lead terminals 1t are arranged in a plurality of rows.

### Embodiment 7

FIG. 11 is a diagram used to illustrate a relationship between the diameter of irradiation light and a detection target tip position according to Embodiment 7 of the present invention.

The relationship between the diameter φb of irradiation light LBia, LBib (hereinafter simply referred to as “irradiation light LBi”) and a detection target tip position Ldet will be described as Embodiment 7. When a lead terminal 1t having a specified length Lsp (a set length) is inspected, a minimum allowable length Lmin that is about 90 percent of the specified length Lsp is set as inspection criterion. Accordingly, a detection target tip position Ldet is set between the specified length Lsp and the minimum allowable length Lmin.

For example, when the lead terminal 1t has a width W in the irradiation direction of the irradiation light LBi of 0.5 mm, and the detection (inspection) of the lead terminal 1t is performed in a state in which 1 mm from the tip (i.e., the specified length Lsp the minimum allowable length Lmin=1 mm) is allowed, if the irradiation light LBi is irradiated on the assumption that the diameter φb of the irradiation light LBi at a position of the lead terminal 1t at which the irradiation light LBi is irradiated is 0.3 mm, and an irradiation position length Lfp extending to the center of the irradiation light LBi is 0.5 mm, the detection target tip position Ldet will be 0.65 mm (the irradiation position length Lfp+the diameter φb/2=0.5+0.15=0.65).

At the lead terminal 1ta located at a specified position that corresponds to the detection target tip position Ldet, reflected light LBr due to irradiation light LBi, or an interruption of the irradiation light LBi occurs. At the lead terminal 1tb having a shorter length, the generation of reflected light LBr due to irradiation light LBi or an interruption of the irradiation light LBi does not occur. Accordingly, as shown in Embodiments 1 to 6, the inspection of the lead terminals 1t can be achieved.

According to this embodiment, it is possible to detect the lead terminal 1tb having a length which does not reach the detection target tip position Ldet=0.65 mm, and the inspection can be performed on the minimum allowable length Lmin (=1 mm) with a sufficient allowance.

Furthermore, even if the diameter is changed from 0.3 mm to, for example, 0.4 mm and the irradiation position length Lfp is changed to, for example, 0.6 mm, the detection target tip position Ldet will be 0.8 mm (the irradiation position length Lfp+the diameter φb/2=0.6+0.2=0.8). Accordingly, it is possible to determine the condition of a position 1 mm from the tip of the lead terminal 1t, which serves as a determination criterion for acceptability, in a secure manner, and thus highly accurate determination can be performed.

By using, as the light emitting unit 11, a semiconductor laser, a semiconductor light emitting diode, an appropriate lens, or the like, the diameter φb can be reduced to about 0.1 mm, and a highly accurate detection can be achieved. Furthermore, when the diameter φb is increased to be greater than that of the lead terminal 1t, a detection error may occur due to the dispersion of the irradiation light LBi. Accordingly, in order to secure the detection accuracy, it is desirable that the diameter φb is set to be not greater than the width Wt of the lead terminal 1t.

The present invention can be embodied and practiced in other different forms without departing from the gist and essential characteristics thereof. Therefore, the above-described embodiments are considered in all respects as illustrative and not restrictive. The scope of the invention is indicated by the appended claims rather than by the foregoing description. All variations and modifications falling within the scope of the appended claims are intended to be embraced therein.

1. A lead terminal inspection method for inspecting the shape condition of lead terminals of an electronic apparatus by irradiating irradiation light from an optical sensor to the lead terminals and detecting reflected light reflected from the lead terminals with the optical sensor,
the optical sensor being configured to irradiate irradiation light having a diameter not greater than the width in the irradiation direction of the lead terminals to a detection target tip position of each lead terminal and detect reflected light reflected from the lead terminal,
wherein the irradiation of the irradiation light and the detection of the reflected light are performed successively for the plurality of lead terminals by relatively moving either one of the optical sensor and the lead terminals relative to the other in the arrangement direction of the lead terminals, thereby counting the number of the lead terminals.

2. The lead terminal inspection method according to claim 1, wherein while the electronic apparatus is fixed, the optical sensor is moved.

3. The lead terminal inspection method according to claim 1, wherein while the optical sensor is fixed, the lead terminals are moved.

4. A lead terminal inspection method for inspecting the shape condition of lead terminals of an electronic apparatus by disposing a light emitting unit of an optical sensor and a light receiving unit of the optical sensor such that the light emitting unit and the light receiving unit face each other in a direction that intersects with the arrangement direction of the lead terminals, irradiating irradiation light from the light emitting unit to the lead terminals, and detecting the irradiation light with the light receiving unit,
the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal,
wherein the irradiation of the irradiation light and the detection of an interruption of the irradiation light are performed successively for the plurality of lead terminals by relatively moving either one of the optical sensor and the lead terminals relative to the other in the arrangement direction, thereby counting the number of the lead terminals.

5. The lead terminal inspection method according to claim 4, wherein while the electronic apparatus is fixed, the light emitting unit and the light receiving unit are moved in synchronization with each other.

6. The lead terminal inspection method according to claim 4, wherein while the light emitting unit and the light receiving unit are fixed, the lead terminals are moved.

7. A lead terminal inspection method for inspecting the shape condition of lead terminals of an electronic apparatus by disposing a light emitting unit of an optical sensor and a light receiving unit of the optical sensor such that the light emitting unit and the light receiving unit face each other in a direction that intersects with the arrangement direction of the lead terminals, irradiating irradiation light from the light emitting unit to the lead terminals, and detecting the irradiation light with the light receiving unit,
the lead terminals being arranged in a plurality of rows, the sensor being disposed in a direction that the irradiation light intersects obliquely with the arrangement direction, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal,
wherein the irradiation of the irradiation light and the detection of an interruption of the irradiation light are performed successively for the plurality of lead terminals by relatively moving either one of the optical sensor and the lead terminals relative to the other in the arrangement direction, thereby counting the number of the lead terminals.

8. A lead terminal inspection apparatus that performs inspection of the shape condition of lead terminals of an electronic apparatus by irradiating irradiation light from a light emitting unit to the lead terminals and detecting reflected light reflected from the lead terminals with a light receiving unit,
the light emitting unit being configured to irradiate irradiation light having a diameter not greater than the width in the irradiation direction of the lead terminals to a detection target tip position of each lead terminal, the light receiving unit being configured to detect reflected light reflected from the lead terminals,
the lead terminal inspection apparatus comprising: an optics moving unit that moves the light emitting unit and the light receiving unit in the arrangement direction of the lead terminals, so that the irradiation of the irradiation light and the detection of the reflected light are performed successively for the plurality of lead terminals; a counting unit that counts the number of the lead terminals by detecting the reflected light; and a comparison/determination unit that determines whether or not the lead terminals are acceptable by comparing the number counted by the counting unit with a predetermined specified number.

9. A lead terminal inspection apparatus that performs inspection of the shape condition of lead terminals of an electronic apparatus by irradiating irradiation light from a light emitting unit to the lead terminals and detecting reflected light reflected from the lead terminals with a light receiving unit,
the light emitting unit being configured to irradiate irradiation light having a diameter not greater than the width in the irradiation direction of the lead terminals to a detection target tip position of each lead terminal, the light receiving unit being configured to detect reflected light reflected from the lead terminals,
the lead terminal inspection apparatus comprising: an apparatus moving unit that moves the electronic apparatus in the arrangement direction of the lead terminals, so that the irradiation of the irradiation light and the detection of the reflected light are performed successively for the plurality of lead terminals; a counting unit that counts the number of the lead terminals by detecting the reflected light; and a comparison/determination unit that determines whether or not the lead terminals are acceptable by comparing the number counted by the counting unit with a predetermined specified number.

10. The lead terminal inspection apparatus according to claim 8, wherein the light emitting unit and the light receiving unit are mounted in the same package.

11. The lead terminal inspection apparatus according to claim 9, wherein the light emitting unit and the light receiving unit are mounted in the same package.

12. A lead terminal inspection apparatus comprising a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit,
the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal,
the lead terminal inspection apparatus comprising: an optics link moving unit that moves the light emitting unit and the light receiving unit in synchronization with each other in the arrangement direction, so that the irradiation of the irradiation light and the detection of an interruption of the irradiation light are performed successively for the plurality of lead terminals; a counting unit that counts the number of the lead terminals by detecting the interruption of the irradiation light; and a comparison/determination unit that determines whether or not the lead terminals are acceptable by comparing the number counted by the counting unit with a predetermined specified number.

13. A lead terminal inspection apparatus comprising a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit,
the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal,
the lead terminal inspection apparatus comprising: an apparatus moving unit that moves the electronic apparatus in the arrangement direction, so that the irradiation of the irradiation light and the detection of an interruption of the irradiation light are performed successively for the plurality of lead terminals; a counting unit that counts the number of the lead terminals by detecting the interruption of the irradiation light; and a comparison/determination unit that determines whether or not the lead terminals are acceptable by comparing the number counted by the counting unit with a predetermined specified number.

14. A lead terminal inspection apparatus comprising a light emitting unit disposed in a direction that intersects with the arrangement direction of lead terminals of an electronic apparatus, and a light receiving unit disposed such that the light receiving unit faces the light emitting unit, that performs inspection of the shape condition of the lead terminals by irradiating irradiation light from the light emitting unit to the lead terminals, and detecting the irradiation light with the light receiving unit,
the lead terminals being arranged in a plurality of rows, the light emitting unit and the light receiving unit being disposed in a direction that the irradiation light intersects obliquely with the arrangement direction, the light emitting unit being configured to irradiate irradiation light having a diameter not greater than the width in the irradiation direction of the lead terminals to a detection target tip position of each lead terminal, and the light receiving unit being configured to detect an interruption of the irradiation light caused by the lead terminal,
the lead terminal inspection apparatus comprising: an apparatus moving unit that moves the electronic apparatus in the arrangement direction, so that the irradiation of the irradiation light and the detection of an interruption of the irradiation light are performed successively for the plurality of lead terminals; a counting unit that counts the number of the lead terminals by detecting the interruption of the irradiation light, and a comparison/determination unit that determines whether or not the lead terminals are acceptable by comparing the number counted by the counting unit with a predetermined specified number.

15. The lead terminal inspection apparatus according to claim 8, wherein the electronic apparatus is an electronic tuner.

16. The lead terminal inspection apparatus according to claim 9, wherein the electronic apparatus is an electronic tuner.

17. The lead terminal inspection apparatus according to claim 10, wherein the electronic apparatus is an electronic tuner.

18. The lead terminal inspection apparatus according to claim 11, wherein the electronic apparatus is an electronic tuner.

19. The lead terminal inspection apparatus according to claim 12, wherein the electronic apparatus is an electronic tuner.

20. The lead terminal inspection apparatus according to claim 13, wherein the electronic apparatus is an electronic tuner.
